(19) United States
(12) Patent Application Publication
(10) Pub. No.: US 2026/0141479 A1
(43) Pub. Date: May 21, 2026

(54) HOMOGRAPHIC DEFORMED CNN FOR ROBUST 3D PERCEPTION

(71) Applicant: Robert Bosch GmbH, Stuttgart (DE)

(72) Inventors: Yuliang Guo, Redwood City, CA (US); Ruoyu Wang, Sunnyvale, CA (US); Cheng Zhao, Milpitas, CA (US); Xinyu Huang, San Jose, CA (US); Liu Ren, Saratoga, CA (US); Abhinav Kumar, East Lansing, MI (US)

(21) Appl. No.: 18/950,829

(22) Filed: Nov. 18, 2024

(51) Int. Cl. G06T 3/4046; G06T 3/4007

(52) U.S. Cl. CPC G06T 3/4046; G06T 3/4007

(57) ABSTRACT

A computer-implemented method and system relate to an image encoder that receives a digital image as input. The image encoder generates a weight map using a preceding feature map. The preceding feature map is generated using pixels of the digital image. The weight map is generated based on lie data associated with the digital image. A homographic transformation is interpolated between two planar projections of the digital image using at least the weight map and a homography matrix. The homography matrix provides a mapping between the two planar projections of the digital image. Homographic transformed kernels are generated by applying the homographic transformation to convolution kernels. The homographic transformed kernels are applied to the preceding feature map to conduct convolution on different plane regions appearing in the digital image and generate a new feature map, which is used for a computer vision task involving three-dimensional (3D) perception.

### TECHNICAL FIELD

This disclosure relates generally to computer vision, and more particularly to digital image processing with a homographic deformed convolutional neural network (CNN) for robust 3D perception.

### BACKGROUND

Monocular three-dimensional (3D) object detection is a task that is used for many applications, such as autonomous driving, robotics, and other technology. To extract the necessary information from dense image pixels, convolutional neural network (CNN) based image encoders are often used for this task. In general, CNN-based image encoders encode images into feature maps, which are further used in object detection. However, most of the existing methods are overfitted in training to a camera's setup or viewpoint. Differences in the mounting positions and orientations of cameras between the training dataset and testing dataset can lead to significant performance drops in object detection.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a computer-implemented method includes receiving, via an image encoder, a digital image. The method includes generating, via the image encoder, a preceding feature map using pixels of the digital image. The method includes generating, via the image encoder, a weight map using the preceding feature map. The weight map includes a set of weights. The set of weights is generated based on manifold data associated with the digital image. The method includes interpolating, via the image encoder, a homographic transformation between two planar projections of the digital image. The homographic transformation is interpolated using at least the weight map and a homography matrix. The homography matrix provides a mapping between the two planar projections. The method includes generating, via the image encoder, a homographic transformed kernel by applying the homographic transformation to a convolution kernel. The method includes generating, via the image encoder, a new feature map by performing a convolution operation using the homographic transformed kernel and the preceding feature map.

According to at least one aspect, a system includes one or more processors and one or more computer memory. The one or more computer memory are in data communication with the one or more processors. The one or more computer memory include computer readable data stored thereon. The computer readable data include instructions that, when executed by one or more processors, causes the one or more processors to perform a method. The method includes receiving, via a convolutional neural network (CNN), a digital image. The method includes generating, via the CNN, an input feature map using pixels of the digital image. The method includes generating, via the CNN, a new feature map by performing a homographic transformed convolution on the input feature map. The homographic transformed convolution includes generating a weight map using the input feature map. The weight map includes a set of weights. The weight map is generated based on manifold data associated with the digital image. The homographic transformed convolution includes interpolating a homographic transformation between two planar projections of the digital image. The homographic transformation is interpolated using at least the weight map and a homography matrix. The homography matrix provides a mapping between the two planar projections. The homographic transformed convolution includes generating a homographic transformed kernel by applying the homographic transformation to a convolution kernel. The homographic transformed convolution includes generating a new feature map by performing a convolution operation using the homographic transformed kernel and the preceding feature map.

These and other features, aspects, and advantages of the present invention are discussed in the following detailed description in accordance with the accompanying drawings throughout which like characters represent similar or like parts. Furthermore, the drawings are not necessarily to scale, as some features could be exaggerated or minimized to show details of particular components.

### BRIEF DESCRIPTION OF THE FIGURES

FIG. 1 is a diagram that illustrates aspects of an example of an image encoder with homographic transformed convolutions according to at least one example embodiment of this disclosure.

FIG. 2 is a diagram that illustrates aspects of a homographic transformed convolution according to an example embodiment of this disclosure.

FIG. 3 is a diagram that illustrates aspects of an example of a homographic transformer of FIG. 2 according to at least one example embodiment of this disclosure.

FIG. 4 is a diagram of an example of system with a machine learning system that performs homographic transformed convolutions via the image encoder of FIG. 1 according to at least one example embodiment of this disclosure.

FIG. 5 is a diagram of an interaction between a computer-controlled machine and a control system according to at least one example embodiment of this disclosure.

FIG. 6 is a diagram of the control system of FIG. 5 that is configured to control a mobile machine, which is at least partially or fully autonomous, according to at least one example embodiment of this disclosure.

FIG. 7 is a diagram of the control system of FIG. 5 that is configured to control a manufacturing machine of a manufacturing system, such as part of a production line, according to at least one example embodiment of this disclosure.

FIG. 8 depicts a schematic diagram of the control system of FIG. 5 that is configured to control a monitoring system according to at least one example embodiment of this disclosure.

FIG. 9 depicts a schematic diagram of the control system of FIG. 5 that is configured to control a medical imaging system according to at least one example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling with the spirit and scope of this disclosure.

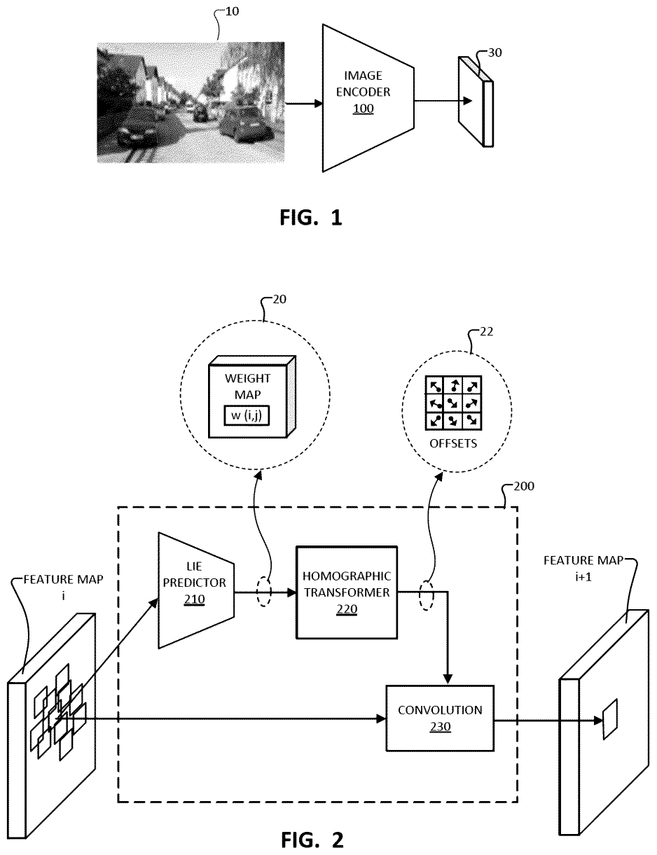

FIG. 1 illustrates an innovative image encoder 100, which applies homographic transformed kernels 22 to perform homographic transformed convolutions 200 on different plane regions that appear in the digital images. By performing homographic transformed convolutions 200, this image encoder 100 is advantageous in that this image encoder 100 is configured to operate with a number of parameters that is less than a number of parameters of a standard CNN image encoder, thereby reducing the parameter load. This image encoder 100 also improves the generalization of image encoding with respect to different camera locations between a training phase and a testing phase.

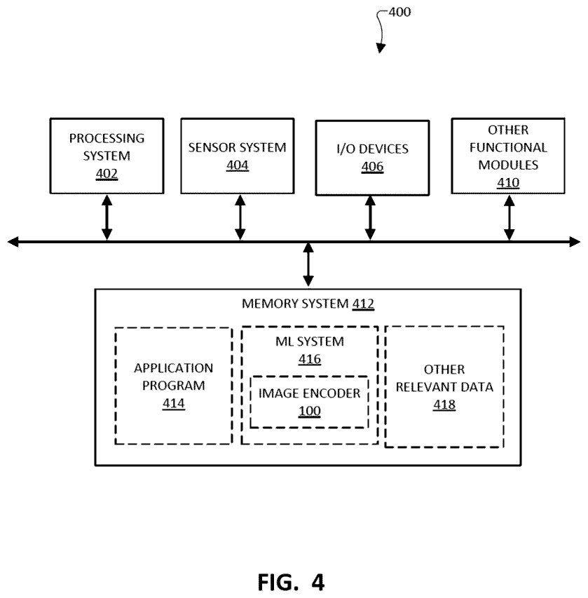

FIG. 1 provides a general overview of the image encoder 100. As shown in FIG. 1, the image encoder 100 is configured to receive at least one digital image 10 as input. The digital image 10 comprises pixels that display an image, such as a scene. As a non-limiting example, in FIG. 1, the digital image 10 is an red green blue (RGB) image or any applicable image. In this non-limiting example, the digital image 10 displays a front view of a road between two rows of houses in which cars are parallel parked on both sides of the road. In response to receiving the digital image 10 as input, the image encoder 100 is configured to generate a feature map 30 as output. Although FIG. 1 only depicts the input (e.g., digital image 10) and output (e.g., feature map 30), the image encoder 100 may generate a number of feature maps during the encoding process of generating the feature map 30. The feature map 30, which is output by the image encoder 100, may thus be referred to as the “output feature map 30.” The output feature map 30 is advantageous in capturing different relationships between different features of the digital image 10. In FIG. 1, after being generated by the image encoder 100, the output feature map 30 is directly or indirectly used via a machine learning (ML) system (e.g., ML system 416 of FIG. 4) in performing a computer vision task (e.g., image classification, object detection, object recognition, semantic segmentation, etc.)

As discussed above, the image encoder 100 generates the output feature map 30 using at least the pixels of the digital image 10. Specifically, the image encoder 100 has an architecture that includes at least a homographic deformed CNN. The homographic deformed CNN includes a number of convolutional layers. The homographic deformed CNN applies a homographic transformed convolution 200 to each convolutional layer of a CNN. In this regard, the homographic deformed CNN performs a number of homographic transformed convolutions 200 to generate the output feature map 30. For example, the image encoder 100 includes a CNN (e.g., ResNet50 or an applicable convolutional model) in which a number of homographic transformed convolutions 200 is applied to a number of convolutional layers of the CNN. The image encoder 100 is configured to extract specific features from the digital image 10 via different homographic transformed kernels 22 (e.g., filters) associated with the homographic transformed convolutions 200.

FIG. 2 illustrates aspects of an example of a homographic transformed convolution 200. As shown in FIG. 2, the homographic transformed convolution 200 includes a process for merging two sets of information (e.g., the input data and the homographic transformed kernel 22). The homographic transformed convolution 200 receives input data and generates a new feature map using the input data. Depending upon when a particular homographic transformed convolution 200 occurs within an encoding process of the image encoder 100, the homographic transformed convolution 200 may receive input data that includes (i) the digital image 10 if this homographic transformed convolution 200 is associated with the first convolutional layer of the image encoder 100 or (ii) a preceding feature map (e.g., “feature map i” where i represents an integer number) that is output from a prior homographic transformed convolution 200 of a prior convolutional layer of the image encoder 100. The preceding feature map may also be referred to as an “input feature map” for being the input to the homographic transformed convolution 200. Upon receiving the input data (e.g., digital image or preceding feature map), the homographic transformed convolution 200 is configured to generate a new feature map (e.g. “feature map i+1”), which may also be referred to as a next feature map or the output feature map 30 depending upon a position of its convolutional layer in the image encoder 100.

Referring to FIG. 2, as an example, the homographic transformed convolution 200 includes a lie predictor 210, a homographic transformer 220, and a convolution step 230. In this example, the homographic transformed convolution 200 is configured to receive the input data (e.g., a digital image or a preceding feature map) via the lie predictor 210. In response to receiving this input data, the lie predictor 210 is configured to generate a weight map 20 using the input data. The lie predictor 210 generates the weight map 20 based on lie algebra and manifold data with respect to the input data (e.g., digital image or preceding feature map). The lie predictor 210 comprises a set of CNN layers, which are supervised to generate a weight map 20. The set of CNN layers include one or more CNN layers. The weight map 20 includes a collection of weights that are associated with the digital image 10, where each weight (w) is associated with coordinates (i,j) that is associated with a pixel location of the digital image 10. The lie predictor 210 is configured to transmit the weight map 20 to the homographic transformer 220.

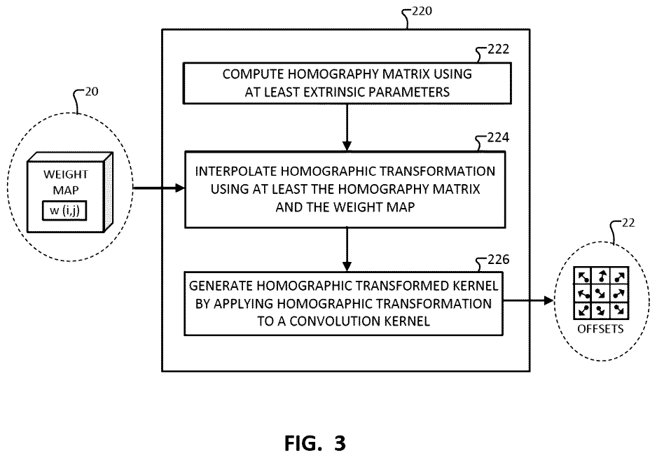

FIG. 3 is a flow diagram that illustrates aspects of a process of the homographic transformer 220 according to an example embodiment. The process may include more steps or less steps than those steps shown in FIG. 2 provided that the same or substantially similar functions and/or results are achieved. As an example, the process is executed by one or processors of the processing system 402 (FIG. 4) or any processing technology.

At step 222, according to an example, the homographic transformer 220 is configured to compute a homography matrix (denoted as D_{im2g}). In general, the homography matrix maps images of points which lie on a world plane from one camera view to another camera view. In this case, the homography matrix describes a mapping between image-to-ground (denoted as im2g in D_{im2g}) plane regions using extrinsic parameters associated with the digital image 10. The homography matrix (D_{im2g}) provides information that includes (i) pose data of the camera associated with the digital image 10 in the real world and (i) ground data of the ground in the real world. The pose data may be obtained from extrinsic parameters associated with the digital image 10. The extrinsic parameters describe the pose of the camera in the real world. The extrinsic parameters describe how the camera is positioned in space. The extrinsic parameters include orientation data and location data of the camera when generating the digital image 10. For example, the extrinsic parameters may include rotation data and translation data of the camera in the real world when generating the digital image 10. The ground data refers to the ground plane in the real world.

At step 224, according to an example, the homographic transformer 220 is configured to interpolate a homographic transformation of the digital image 10 between two projection planes (e.g. the image plane and the ground plane). Specifically, the homographic transformer 220 is configured to interpolate the homographic transformation using the homography matrix (denoted as D_{im2g}), and the weight map 20 (w), as expressed in equation 1. As aforementioned, the homographic transformer 220 is configured to receive the weight map 20 from the lie predictor 210. The homographic transformer 220 is also configured to use an identity matrix (denoted as I) to compute the homographic transformation. For instance, in this example, the homographic transformation is represented as a matrix, which is computed using equation 1. As expressed below, equation 1 shows some equivalent expressions for representing and evaluating the homographic transformation. In equation 1, P represents an invertible matrix and A represents eigenvalues. In this regard, λ₁, λ₂, and A₃ represent eigenvalues. In equation 1, each eigenvalue is taken to the power of w.

$$Homographic Transformation = {D}_{im 2 g}^{w} {I}^{1 - w} = {D}_{im 2 g}^{w} = P [ \begin{matrix}{λ}_{1}^{w} & 0 & 0 \\ 0 & {λ}_{2}^{w} & 0 \\ 0 & 0 & {λ}_{3}^{w}\end{matrix} ] {P}^{- 1} \qquad [ 1 ]$$

At step 226, according to an example, the homographic transformer 220 is configured to apply the homographic transformation to at least one standard convolution kernel to generate a new kernel, which may be referred to as a homographic transformed kernel 22. The homographic transformer 220 is configured to use the homographic transformation, which comprises a matrix, to generate a homographic transformed kernel 22 by transforming a standard convolution kernel to a different shape by offset data (e.g., a set of offsets). As an example, the homographic transformation's matrix may be multiplied by standard sampling locations of the convolution kernel to obtain new sampling locations. In this regard, each difference between a standard sampling location and a new sampling location represents a respective offset. The convolution kernel may comprise a rectangular shape of any applicable size. In this regard, the convolution kernel may be a 3×3 grid, a 3×5 grid, a 6×3 grid, 2×2 grid, or any m×n grid (where m and n represent integer numbers), which is selected to prevent overfitting or underfitting. For example, in FIG. 3, the homographic transformed kernel 22 is an offset version of a standard 3×3 convolution kernel in that the homographic transformed kernel 22 includes new sampling locations, which are offset from the standard sampling locations of the standard 3×3 convolution kernel. In this regard, when the homographic transformation's matrix is applied to the standard convolution kernel, then the homographic transformed kernel 22 is generated by dynamically adjusting the sampling locations with learnable offsets. The homographic transformed kernel 22 is advantageous in modeling an improved spatial relationship with the input data (e.g., the input/preceding feature map).

Referring back to FIG. 1, the homographic transformer 220 is configured to perform a convolution step 230 using the input data (e.g., digital image 10 or preceding feature map) and the homographic transformed kernel 22. The convolution step 230 includes a neural network convolution between the homographic transformed kernel 22 and the input data (e.g., digital image 10 or preceding feature map). Specifically, the convolution step 230 includes convolving the input data (e.g., the digital image or the preceding feature map) with the homographic transformed kernel 22 to generate a new feature map (e.g., a next feature map or the output feature map 30). The homographic transformed kernel 22 is configured to extract features from the digital image 10 when generating the new feature map (e.g. “feature map i+1”).

As aforementioned, the image encoder 100 is configured to perform a number of homographic transformed convolutions 200 to generate the output feature map 30, which is used downstream by other components of the ML system 416. In this regard, a number of feature maps may be generated in a process of generating the output feature map 30 from the digital image 10. Also, the image-to-ground homography matrix D_{im2g} may be computed differently when there are different camera installations for the training dataset used during the training phase of the image encoder 100 and the testing dataset used during the testing phase of the image encoder 100. In this regard, the image encoder 100 is configured to improve a computer vision task of an ML system (e.g., ML system 416) with respect to its robustness to different camera setups between the training dataset and the testing dataset.

FIG. 4 is a block diagram of an example of a system 400 that includes an ML system 416 configured to perform a computer vision task. The system 400 includes at least a processing system 402. The processing system 402 includes at least one processing device. For example, the processing system 402 may include an electronic processor, a central processing unit (CPU), a graphics processing unit (GPU), a tensor processing unit (TPU), a microprocessor, a field-programmable gate array (FPGA), an application-specific integrated circuit (ASIC), any processing technology, or any number and combination thereof. The processing system 402 is operable to provide the functionality as described herein.

The system 400 includes at least one sensor system 404. The sensor system 404 includes one or more sensors. For example, the sensor system 404 includes at least an image sensor, such as a camera that generates digital images. The sensor system 404 may include at least one other type of sensor (e.g., radar, LiDAR, infrared, etc.) to obtain additional sensor data, whereby the sensor system 404 may generate digital images based on this additional sensor data. The sensor system 404 is operable to communicate with one or more other components (e.g., processing system 402 and memory system 412) of the system 400. For example, the sensor system 404 may provide sensor data (e.g., digital images), which is then processed by the processing system 402. The sensor system 404 is local, remote, or a combination thereof (e.g., partly local and partly remote) with respect to one or more components of the system 400. Upon receiving the sensor data (e.g., one or more digital images), the processing system 402 is configured to process this sensor data (e.g. digital images) in connection with the application program 414, the ML system 416, the other relevant data 418, or any number and combination thereof.

The system 400 includes a memory system 412, which is operatively connected to the processing system 402. In this regard, the processing system 402 is in data communication with the memory system 412. The memory system 412 includes at least one non-transitory computer readable storage medium, which is configured to store and provide access to various data to enable at least the processing system 402 to perform the operations and functionality, as disclosed herein. The memory system 412 comprises a single memory device or a plurality of memory devices. The memory system 412 may include electrical, electronic, magnetic, optical, semiconductor, electromagnetic, or any suitable storage technology. For instance, the memory system 412 may include random access memory (RAM), read only memory (ROM), flash memory, a disk drive, a memory card, an optical storage device, a magnetic storage device, a memory module, any suitable type of memory device, or any number and combination thereof.

The memory system 412 includes computer readable data that, when executed by the processing system 402, is configured to perform at least the functions disclosed in this disclosure. The computer readable data may include instructions, code, routines, various related data, software technology, or any number and combination thereof. In this regard, the memory system 412 includes computer readable data for the application program 414. The application program 414 is configured to perform the functions discussed in this disclosure such as the processes relating to the ML system 416. For example, the application program 414 may relate to the ML system 416 with respect to training, testing, deploying, employing, or any combination thereof. The application program 414 may also be configured to apply the output data of the ML system 416 to a computer vision application.

The memory system 412 includes computer readable data for the ML system 416. As an example, in FIG. 4, the ML system 416 includes at least the image encoder 100 (FIG. 1). Depending on the computer vision task (e.g. semantic segmentation) and downstream application, the ML system 416 may include at least one other ML component (e.g., an image decoder, additional layers, etc.). The image encoder 100 is configured to perform the operations and functions as discussed with respect to FIG. 1, FIG. 2, and FIG. 3. As an example, in FIG. 4, the ML system 416 is configured to perform classification or 3D object detection.

The memory system 412 includes computer readable data for the other relevant data 418. The other relevant data 418 provides various data (e.g., operating system, etc.), which enables the system 400 and/or the processing system 402 to perform the functions as discussed herein. In addition, the system 400 may include one or more I/O devices 406 (e.g., display device, microphone, speaker, etc.).

In addition, the system 400 includes other functional modules 410, such as any appropriate hardware, software, or combination thereof that assist with or contribute to the functioning of the system 400 and the ML system 416 and/or the image encoder 100. For example, the other functional modules 410 include communication technology (e.g., wired communication technology, wireless communication technology, or a combination thereof) that enables components of the system 400 to communicate with each other and/or one or more other computing devices (not shown), e.g., mobile communication device, smart phone, laptop, tablet, server, a cloud computing system, etc.

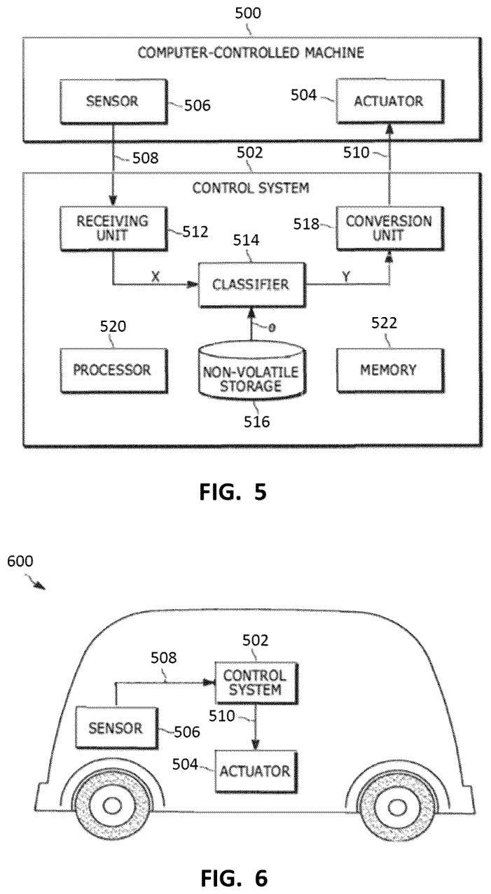

FIG. 5 depicts a schematic diagram of an interaction between computer-controlled machine 500 and control system 502 according to another example embodiment. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. A non-limiting example of sensor 506 includes video, radar, LiDAR, an ultrasonic sensor, an image sensor, an audio sensor, a motion sensor, etc. In some embodiments, sensor 506 is an image sensor or an optical sensor configured to provide digital images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to a digital image recorded by sensor 506.

Control system 502 includes classifier 514. In this example, the classifier 514 includes the trained ML system 416. The classifier 514 may be configured to classify input signals x into one or more labels using ML algorithms. Classifier 514 is configured to be parametrized by parameters θ. Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504. As shown in FIG. 5, control system 502 also includes processor 520 and memory 522. Processor 520 may include one or more processors. Memory 522 may include one or more memory devices. The classifier 514 (i.e., the trained ML system 416) of one or more embodiments may be implemented by control system 502, which includes non-volatile storage 516, processor 520, and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, graphics processing units, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, RAM, ROM, volatile memory, non-volatile memory, static random access memory (SRAM), dynamic random access memory (DRAM), flash memory, cache memory, or any other device capable of storing information.

Processor 520 is configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies to employ the classifier 514 as disclosed herein. Non-volatile storage 516 may also include ML data (including model parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments. Furthermore, the processes, methods, or algorithms can be embodied in whole or in part using suitable hardware components, such as ASICs, FPGAs, state machines, controllers or other hardware components or devices, or a combination of hardware, software and firmware components.

FIG. 6 depicts a schematic diagram of control system 502 configured to control vehicle 600, which may be at least a partially autonomous vehicle or a partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. Global Positioning System). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate to the vehicle 600 or at another location.

The classifier 514 of control system 502 of vehicle 600 may be configured to classify objects in the vicinity of vehicle 600 dependent on input signals x. In such an embodiment, output signal y may include information classifying or characterizing objects in a vicinity of the vehicle 600. Actuator control command 510 may be determined in accordance with this information. The actuator control command 510 may be used to navigate the vehicle 600 and avoid collisions based on the classifications provided by classifier 514.

In some embodiments, the vehicle 600 is an at least partially autonomous vehicle or a fully autonomous vehicle. The actuator 504 may be embodied in a brake, a propulsion system, an engine, a drivetrain, a steering of vehicle 600, etc. Actuator control commands 510 may be determined such that actuator 504 is controlled such that vehicle 600 avoids collisions with detected objects. Detected objects may also be identified and classified according to what the classifier 514 deems them most likely to be, such as pedestrians, trees, any suitable labels, etc. The actuator control commands 510 may be determined depending on the classification of objects from digital images generated via the sensors 506.

In some embodiments where vehicle 600 is at least a partially autonomous robot, vehicle 600 may be a mobile robot that is configured to carry out one or more functions, such as flying, swimming, diving, stepping, or another mobile action. The mobile robot may be a lawn mower, which is at least partially autonomous, or a cleaning robot, which is at least partially autonomous. In such embodiments, the actuator control command 510 may be determined such that a propulsion unit, steering unit and/or brake unit of the mobile robot may be controlled such that the mobile robot may navigate and/or avoid collisions with objects according to classifications provided by the classifier 514.

In some embodiments, vehicle 600 is an at least partially autonomous robot in the form of a gardening robot. In such embodiment, vehicle 600 may use an optical sensor as sensor 506 to determine a state of plants in an environment proximate to vehicle 600. Actuator 504 may be a nozzle configured to spray chemicals. Depending on an identified species and/or an identified state of the plants via the classifier 514, actuator control command 510 may be determined to cause actuator 504 to spray the plants with a suitable quantity of suitable chemicals.

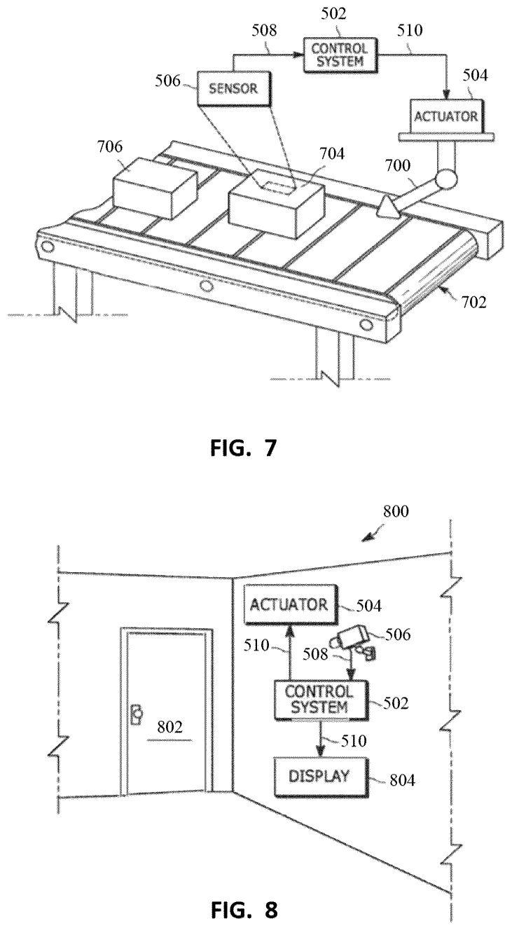

FIG. 7 depicts a schematic diagram of control system 502 configured to control a system 700 (e.g., manufacturing machine), which may include a punch cutter, a cutter, a gun drill, or the like, of a manufacturing system 702, such as part of a production line. Control system 502 may be configured to control actuator 504, which is configured to control the system 700 (e.g., manufacturing machine).

Sensor 506 of the system 700 (e.g., manufacturing machine) may be an optical sensor configured to capture one or objects associated with manufacturing a product 704. Classifier 514 may be configured to determine from one or more of the captured properties. Actuator 504 may be configured to control the system 700 (e.g., manufacturing machine) depending on the determined state of a manufacturing of the product 704 for a subsequent manufacturing step of manufacturing the product 704. The actuator 504 may be configured to control functions of the system 700 (e.g., manufacturing machine) on a subsequent state of the product 706 of system 700 (e.g., manufacturing machine) depending on the determined state of the product 704.

FIG. 8 is a diagram of control system 502 configured to control monitoring system 800 (e.g., a security system). Monitoring system 800 may be configured to physically control access through door 802. Sensor 506 may be configured to detect a scene that is relevant in deciding whether access is granted. Sensor 506 may be an optical sensor configured to generate and transmit image and/or video data. Such image and/or video data may be used by control system 502 to detect and classify an object (e.g., human, dog, bicycle, weapon, trash can, recycling bin, etc.) that may be in a sensing region of the sensor 506 near the door 802.

In addition, the control system 502 may be configured to generate an actuator control command 510 in response to the classification of one or more objects of the image and/or video data via the classifier 514. Control system 502 is configured to transmit the actuator control command 510 to actuator 504. In this embodiment, the actuator 504 is configured to lock or unlock door 802 in response to the actuator control command 510. In some embodiments, a non-physical, logical access control is also possible.

Monitoring system 800 may also be a surveillance system. In such an embodiment, the sensor 506 includes at least an image sensor or camera configured to detect a scene that is under surveillance and the control system 502 is configured to control display 804. Classifier 514 is configured to determine a classification of a scene, e.g. whether the scene detected by sensor 506 is suspicious. Control system 502 is configured to transmit an actuator control command 510 to display 804 in response to the classification. Display 804 may be configured to adjust the displayed content in response to the actuator control command 510. For instance, display 804 may highlight an object that is deemed suspicious by classifier 514.

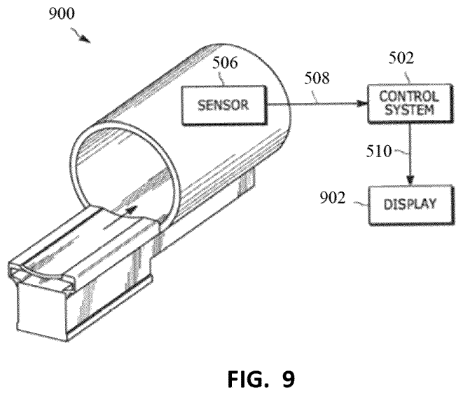

FIG. 9 depicts a schematic diagram of control system 502 configured to control imaging system 900, for example a magnetic resonance imaging (MRI) apparatus, x-ray imaging apparatus or ultrasonic apparatus. Sensor 506 may, for example, be an imaging sensor. Classifier 514 may be configured to determine a classification of all or part of the sensed image. The actuator control command 510 is selected based on the classification obtained from the classifier 514. For example, classifier 514 may interpret a region of a digital image to be potentially anomalous. In this case, the actuator control command 510 may be selected to cause display 902 to display the digital image and highlight the potentially anomalous region.

As described in this disclosure, the embodiments provide a number of advantageous features, as well as benefits. For example, the embodiments include at least an image encoder 100 comprising a CNN with homographic transformed convolutions 200, which improves the generalization capability of the image encoder 100 with respect to different camera setups or viewpoints. Also, the image encoder 100 applies one or more homographic transformed kernels 22 to conduct one or more convolutions on different plane regions appearing in the digital image. A homographic transformed kernel 22 is a sampling matrix that provides shapes that are flexible and adaptable, thereby providing improved 3D feature extraction and 3D perception.

Also, since the image encoder 100 comprises a CNN with homographic transformed convolutions, the image encoder 100 is configured to extract information from dense image pixels and encode this information into feature maps. The image encoder 100 is versatile and usable in various applications, such as monocular three-dimensional (3D) object detection, autonomous driving, robotics, etc. The image encoder 100 is configured to provide improved performance with respect to 3D perception by accounting for any differences in the mounting positions and orientations of cameras between the training dataset and testing dataset.

Furthermore, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. Additionally, or alternatively, components and functionality may be separated or combined differently than in the manner of the various described embodiments and may be described using different terminology. These and other variations, modifications, additions, and improvements may fall within the scope of the disclosure as defined in the claims that follow.

1. A computer-implemented method for computer vision with three-dimensional (3D) perception, the computer-implemented method comprising:
receiving, via an image encoder, a digital image;
generating, via the image encoder, a preceding feature map using pixels of the digital image;
generating, via the image encoder, a weight map using the preceding feature map, the weight map including a set of weights and being generated based on manifold data associated with the digital image;
interpolating, via the image encoder, a homographic transformation between two planar projections of the digital image, the homographic transformation being interpolated using at least the weight map and a homography matrix, the homography matrix providing a mapping between the two planar projections;
generating, via the image encoder, a homographic transformed kernel by applying the homographic transformation to a convolution kernel; and
generating, via the image encoder, a new feature map by performing a convolution operation using the homographic transformed kernel and the preceding feature map.

2. The computer-implemented method of claim 1, wherein:
the weight map is generated by a set of CNN layers of the image encoder, and
the set of CNN layers is configured to generate the weight map by performing lie prediction via the manifold data using the preceding feature map.

3. The computer-implemented method of claim 2, wherein the set of CNN layers is configured to regress an interpolation weight of a ground plane and the digital image.

4. The computer-implemented method of claim 1, wherein the homographic transformed kernel is a version of the convolution kernel that is augmented with offset sampling locations.

5. The computer-implemented method of claim 1, wherein a shape of the homographic transformed kernel is different than a shape of the convolution kernel.

6. The computer-implemented method of claim 1, wherein the two planar projections include (i) an image plane of the digital image and (ii) a ground plane of the digital image.

7. The computer-implemented method of claim 1, further comprising:
generating the homography matrix using extrinsic parameters of a camera when capturing the digital image,
wherein the extrinsic parameters include rotation data and translation data of the camera in world coordinate system.

8. The computer-implemented method of claim 1, wherein the homography matrix is computed (i) during a training phase of training the image encoder with respect to a camera setup associated with a training dataset and (ii) during a testing phase of testing the image encoder with respect the camera setup associated with a testing dataset.

9. The computer-implemented method of claim 1, further comprising:
generating (3D) object detection data based at least on the new feature map, the 3D object detection data identifying an object of interest that is displayed in the digital image; and
controlling an actuator based on the 3D object detection data.

10. A system comprising:
one or more processors;
one or more computer memory in data communication with the one or more processors, the one or more computer memory having computer readable data stored thereon, the computer readable data including instruction that, when executed by one or more processors, causes the one or more processors to perform a method for computer vision with three-dimensional (3D) perception, the method including:
receiving, via a convolutional neural network (CNN), a digital image;
generating, via the CNN, an input feature map using pixels of the digital image;
generating, via the CNN, a new feature map by performing a homographic transformed convolution on the input feature map, the homographic transformed convolution including:
generating a weight map using the input feature map, the weight map including a set of weights and being generated based on manifold data associated with the digital image;
interpolating a homographic transformation between two planar projections of the digital image, the homographic transformation being interpolated using at least the weight map and a homography matrix, the homography matrix providing a mapping between the two planar projections;
generating a homographic transformed kernel by applying the homographic transformation to a convolution kernel; and
performing a convolution operation to generate the new feature map, the convolution operation being between the homographic transformed kernel and the input feature map.

11. The system of claim 10, wherein the weight map is generated by a set of CNN layers of the CNN that perform lie prediction via the manifold data using the input feature map.

12. The system of claim 11, wherein the set of CNN layers performing the lie prediction is configured to regress an interpolation weight of a ground plane and the digital image.

13. The system of claim 10, wherein the homographic transformed kernel is the convolution kernel that is augmented with offset sampling locations.

14. The system of claim 10, wherein a shape of the homographic transformed kernel is different than a shape of the convolution kernel.

15. The system of claim 10, wherein the two planar projections include (i) an image plane of the digital image and (ii) a ground plane of the digital image.

16. The system of claim 10, further comprising:
generating the homography matrix using extrinsic parameters associated with a camera when capturing the digital image,
wherein the extrinsic parameters include rotation data and translation data of the camera in world coordinate system.

17. The system of claim 10, wherein the homography matrix is computed (i) during a training phase with respect to a camera setup associated with a training dataset and (ii) during a testing phase with respect the camera setup associated with a testing dataset.

18. The system of claim 10, further comprising:
generating classification data based at least on the new feature map, the classification data indicating a class to which the digital image belongs; and
controlling an actuator based on the classification data.
